(19) United States
(12) Patent Application Publication
(10) Pub. No.: US 2025/0240426 A1
(43) Pub. Date: Jul. 24, 2025

(54) COMPRESSION OF SPARSE VOLUMETRIC EFFECTS CODEC APPARATUS AND METHOD

(71) Applicant: Zibra AI, Inc., Lewes, DE (US)

(72) Inventor: Mykhailo MOROZ, Lviv (UA)

(21) Appl. No.: 19/028,856

(22) Filed: Jan. 17, 2025

Related U.S. Application Data
(60) Provisional application No. 63/622,701, filed on Jan. 19, 2024.

(51) Int. Cl. H04N 19/13; H04N 19/124; H04N 19/176; H04N 19/62; H04N 19/88; H04N 19/91

(52) U.S. Cl. CPC H04N 19/13; H04N 19/124; H04N 19/176; H04N 19/62; H04N 19/88; H04N 19/91

(57) ABSTRACT

A control circuit is configured to divide a volumetric dataset into a plurality of volumetric blocks, apply a spatial-frequency transform to each of the volumetric blocks to obtain transform-domain coefficients, quantize the transform-domain coefficients according to one or more quantization parameters to provide quantized coefficients, reorder the quantized coefficients based on a scanning order determined to reduce coefficient differences, compose a collection of symbols for each volumetric block, the collection of symbols including at least a block header and a sparse representation of non-zero coefficients, entropy encode at least some of the symbols to generate a compressed bitstream, and store the compressed bitstream in memory.

### CROSS-REFERENCE TO RELATED APPLICATION(S)

This application claims the benefit of U.S. Provisional Application No. 63/622,701 filed Jan. 19, 2024, which is incorporated herein by reference in its entirety.

### TECHNICAL FIELD

The present invention relates to lossy data compression systems in general and sparse volumetric data coding in particular.

### BACKGROUND

It is a common problem in data storage and processing that storing field values explicitly (such as, for example, volumetric samples represented by their position in space (XYZ), their size, their attribute values, and so forth). Whereas attributes can be one of color samples (represented as red, blue, and green primaries, or a combination of luminosity and chromaticity), density, materials, transparency, reflectance, temperature, normals, and so forth) or a combination of thereof is prohibitively memory expensive, thus limiting the applicability of such data in real-time use cases.

Existing methods of storage for such types of data either store the data with limited compression (such as voxel data based/volumetric data blocks (VDB)), are applied on the bit level without regard to the structure of data compressed (such as Lempel-Ziv 77 (LZ77)), are not designed to efficiently represent volumetric 3-dimensional data (such as JPEG, h.264, HEVC, TFAN, G-PCC, or V-PCC), and/or do not support efficient sparse data representation and are not efficient at parallel decoding and encoding (for example, JP3D).

### BRIEF DESCRIPTION OF DRAWINGS

The above needs are at least partially met through provision of the compression of sparse volumetric effects codec apparatus and method described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings;

FIG. 3 comprises a flow diagram as configured in accordance with various embodiments of these teachings;

FIG. 4 comprises a flow diagram as configured in accordance with various embodiments of these teachings;

FIG. 5 comprises a flow diagram as configured in accordance with various embodiments of these teachings;

FIG. 6 comprises a flow diagram as configured in accordance with various embodiments of these teachings;

FIG. 7 comprises a flow diagram as configured in accordance with various embodiments of the invention;

FIG. 8 comprises a sparse representation of volumetric data as configured in accordance with various embodiments of these teachings;

FIG. 9 comprises a spatial-frequency transform of a volumetric block into its spatial-coefficients as configured in accordance with various embodiments of these teachings; and

FIG. 10 comprises a quantization scale of spatial-frequency coefficients inside of a block as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

These teachings can serve to provide a method for fast compression and decompression of sparse scalar fields representing arbitrary volumetric data. The foregoing can include subdividing the original data into a set of sparse blocks, which are pre-processed to improve quality, and which are then subsequently encoded into a sparse compressed representation by transforming each block into the frequency domain, doing a frequency-dependent quantization of this representation, and then storing the result as a set of sparse quantized coefficients with an optimal scanning order that minimizes differences between the coefficients. This transformed representation can thereafter be encoded by using entropy compression methods, first by computing the statistics of the frequency coefficients, building a Huffman tree using them, and then storing the blocks as a bitstream. This compressed data can be efficiently decoded back into its original form with a predefined loss of quality.

Accordingly, these teachings can serve to provide a codec that specifically targets real-time decompression of highly compressed volumetric effects while having a good reconstruction quality.

By one approach, these teachings can provide for control circuit that is configured to divide a volumetric dataset into a plurality of volumetric blocks, apply a spatial-frequency transform to each of the volumetric blocks to obtain transform-domain coefficients, quantize the transform-domain coefficients according to one or more quantization parameters to provide quantized coefficients, reorder the quantized coefficients based on a scanning order determined to reduce coefficient differences, compose a collection of symbols for each volumetric block, the collection of symbols including at least a block header and a sparse representation of non-zero coefficients, entropy encode at least some of the symbols to generate a compressed bitstream, and store the compressed bitstream in memory.

By one approach, the foregoing can further comprise, for unsigned volumetric datasets, introducing a negative offset to voxel values having a density attribute below a user-specified threshold, the negative offset being a product of a zeroOffset parameter and a maximum voxel value within each volumetric block.

By one approach, the aforementioned quantizing of the transform-domain coefficients can include omitting coefficients below a threshold defined by a power-law function of an absolute frequency of a corresponding voxel and a user-specified exponent.

By one approach, the aforementioned quantizing of the transform-domain coefficients can comprise normalizing the transform-domain coefficients by dividing by a block-specific maximum coefficient magnitude, applying a nonlinear quantization function to emphasize smaller coefficients and to provide normalized transform-domain coefficients, and converting the normalized transform-domain coefficients into integer values.

By one approach, the aforementioned reordering of the quantized coefficients can comprise sorting according to coefficient magnitude or by utilizing a space-filling curve to place coefficients with smaller differences adjacent to each other.

By one approach, the aforementioned entropy encoding can comprise encoding non-zero coefficients using a zero-run scheme for intervening zero-valued coefficients, and applying Huffman coding to resulting symbols, wherein multiple Huffman trees are used, each corresponding to a different symbol type.

By one approach, the aforementioned reordering of the quantized coefficients can comprise determining a scanning order by sorting the quantized coefficients according to an average value of each coefficient across a volumetric frame.

By one approach, these teachings will further accommodate normalizing the transform-domain coefficients for each volumetric block to a range of −1 to 1 based on a block-specific maximum absolute coefficient value, and storing a corresponding normalization parameter for each volumetric block in the compressed bitstream such that an original coefficient range can be reconstructed at decoding.

By one approach, when the aforementioned volumetric dataset is unsigned, these teachings can further comprise transforming voxel attribute values by applying a nonlinear function pow(attr[i], α[i]) prior to applying the spatial-frequency transform.

By one approach, these teachings will further accommodate storing a bit offset for each volumetric block's portion of the compressed bitstream, thereby enabling parallel entropy encoding and decoding of multiple blocks on a graphics processing unit or other parallel-processing hardware.

By one approach, these teachings will further accommodate encoding spatial-frequency coefficients by encoding a predefined number N of largest coefficients of spatial-frequency components as a dense array for each volumetric block, and encoding remaining one of the spatial-frequency coefficients using a sparse representation that incorporates zero-run coding.

By one approach, the aforementioned storing of the compressed bitstream in memory comprises storing an encoded bitstream of a plurality of volumetric blocks, each of the volumetric blocks being represented by block properties, including at least a position within a volumetric coordinate space and a count of attributes, and for each attribute of the volumetric blocks a normalization scale indicating a coefficient range for each of the volumetric blocks, a number of dense coefficients, a sequence of dense coefficients, and a sequence of coefficients encoded in a sparse format using zero-run encoding.

By one approach, these teachings can provide for using a control circuit to decode sparse volumetric frames from a compressed bitstream by entropy decoding symbols for each of a plurality of volumetric blocks to provide decoded coefficients, inverse reordering of the decoded coefficients based on a predetermined scanning order to provide inverse reordered decoded coefficients, dequantizing the inverse reordered decoded coefficients to restore approximate transform-domain values, applying an inverse spatial-frequency transform to generate reconstructed volumetric blocks, and performing a post-processing step to finalize voxel values of the reconstructed volumetric blocks.

By one approach, the aforementioned dequantizing of the inverse reordered decoded coefficients can include retrieving a normalization parameter for each volumetric block from the compressed bitstream and multiplying each inverse reordered decoded coefficient by a corresponding normalization parameter to restore the inverse reordered decoded coefficients to at least approximately their original amplitude range.

By one approach, these aforementioned can further comprise applying an inverse of a previously utilized nonlinear function to each voxel's attribute value after dequantizing, wherein the inverse spatial-frequency transform is at least pow(attr[i], −α[i]) to recover approximate original attribute values.

By one approach, the aforementioned decoding of sparse volumetric frames from a compressed bitstream can include using a per-block offset for parallel entropy decoding of multiple volumetric blocks on a graphics processing unit or other parallel-processing hardware.

By one approach, the aforementioned decoding of sparse volumetric frames from a compressed bitstream can include decoding spatial-frequency coefficients by decoding a predefined number N of coefficients as a dense array for each volumetric block, and decoding remaining coefficients using a sparse representation that incorporates zero-run coding.

By one approach, these teachings can provide a non-transitory computer-readable medium comprising instructions stored thereon for encoding sparse volumetric information, which instructions, when executed on a processor, perform the steps of dividing a volumetric dataset into a plurality of volumetric blocks, applying a spatial-frequency transform to each of the volumetric blocks to obtain transform-domain coefficients, quantizing the transform-domain coefficients according to one or more quantization parameters to provide quantized coefficients, reordering the quantized coefficients based on a scanning order determined to reduce coefficient differences, composing a collection of symbols for each volumetric block, the collection of symbols including at least a block header and a sparse representation of non-zero coefficients, entropy encoding at least some of the symbols to generate a compressed bitstream, and storing the compressed bitstream in memory.

By one approach, the aforementioned quantizing of the transform-domain coefficients can comprise normalizing the transform-domain coefficients by dividing by a block-specific maximum coefficient magnitude, applying a nonlinear quantization function to emphasize smaller coefficients and to provide normalized transform-domain coefficients, and converting the normalized transform-domain coefficients into integer values.

By one approach, the aforementioned instructions can further provide for normalizing the transform-domain coefficients for each volumetric block to a range of −1 to 1 based on a block-specific maximum absolute coefficient value, and storing a corresponding normalization parameter for each volumetric block in the compressed bitstream such that an original coefficient range can be reconstructed at decoding.

These teachings are applicable, but not limited, to representing spatial or spatio-temporal volumetric data, such as visual effects like smoke, explosions, volumetric lighting, or fields representing iso-surfaces (such as, for example, liquids) as well as images and video. It will be further appreciated that these teachings offer an approach that is data-agnostic and that is applicable to a wide range of volumetric data, including but not limited to the rendering of large high quality volumetric effects, cached simulations, and volumetric animations as well as volumetric images and video.

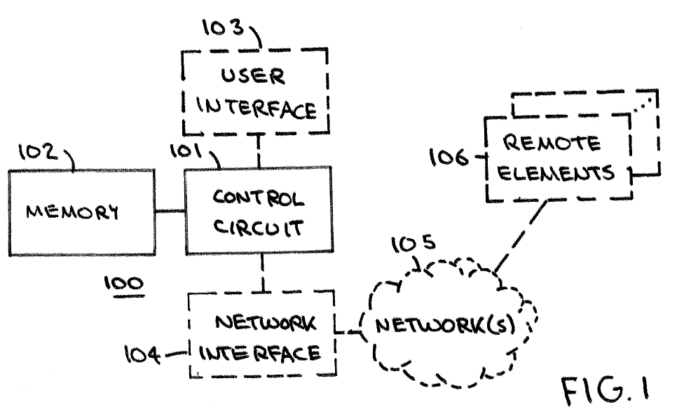

These and other benefits may become clearer upon making a thorough review and study of the following detailed description. Referring now to the drawings, and in particular to FIG. 1, an illustrative apparatus 100 that is compatible with many of these teachings will be presented.

In this particular example, the enabling apparatus 100 includes a control circuit 101 that can serve, at least in part, as a machine learning based codec. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to a central processing (CPU) or graphics processing unit (GPU) of a general purpose computer, a deep learning accelerator (such as TPU), an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

In this illustrative example the control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101). It will also be understood that this memory 102 may comprise a plurality of physically discrete memories that, in the aggregate, store the pertinent information that corresponds to these teachings.

In addition to data to be compressed, this memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as a dynamic random-access memory (DRAM).)

By one optional approach, the control circuit 101 operably couples to a user interface 103. This user interface 103 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

In another optional approach, in lieu of the foregoing or in combination therewith, the control circuit 101 operably couples to a network interface 104. So configured the control circuit 101 can communicate with remote elements 106 via one or more communications/data networks 105. Network interfaces, including both wireless and non-wireless platforms, are well understood in the art and require no particular elaboration here.

Before proceeding further, it may be helpful to first explain some words and expressions that are used herein.

“Volumetric data” refers to a structured aggregation of data points, each representing a quantified attribute within a defined N-dimensional spatial domain. This data is characteristically organized in a regular grid of discrete units referred to as “voxels” (and may also be viewed as volume elements).

“Voxel” refers to a value representing a collection of attributes associated with a point of a defined size and shape and orientation located in space on a regular N-dimensional grid.

“Volumetric block” refers to a set of voxels arranged into a regular rectangular-prismatic structure (for example, 8 by 8 by 8 voxels) with an integer coordinate of the block in a global coordinate system.

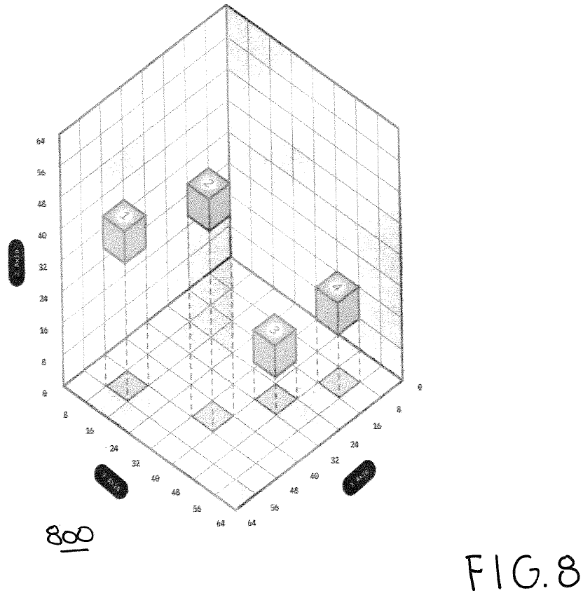

“Sparse representation” refers to, in a regular N-dimensional grid of, for example, volumetric blocks or spatial-frequency coefficients, a sparse representation of a collection of grid nodes with their coordinates on the grid and their attributes. When a grid node of a given coordinate is not in the collection, its attributes are assumed to be equal to zero. FIG. 8 presents an illustrative example of a sparse representation of volumetric data (volume).

“Block coordinate” refers to an offset (in block scale units) of the volumetric block's origin relative to the effect's origin coordinate.

“Frequency domain transform” refers to a method to transform a volumetric block into a set of spatial-frequency coefficients that represents the voxel data in a decorrelated way.

“Block symbol collection” refers to an ordered collection of symbols representing a volumetric block, which holds the header of the block consisting of a constant number of symbols holding information about position, normalization constant for coefficients, the number of attributes and their type, and the payload composed of sparse spatial-frequency coefficients of each attribute split into two parts, a dense collection of coefficients represented as a symbol holding their count and symbols for the coefficients, and the second part being a sparse representation of the rest of the coefficients stored as collection of pairs of symbols holding the coefficient and the run of zeros. If some coefficient symbols are not specified they are assumed to be zero. The beginning of the block can be specified either by a start symbol, or by an offset symbol.

“Displacement vector” refers to a spatial offset at a certain point, which minimizes a difference between two volumes.

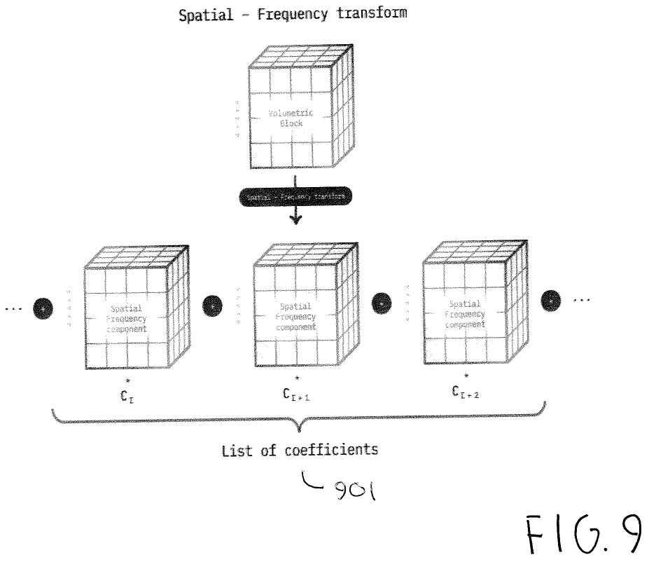

Block transformation into a frequency domain is an approach that provides for receiving the values of the voxels of a given block as an input and which then converts those values and outputs coefficients representing the volume as a weighted sum of basis functions. Usually, these basis functions represent the volume in the format of a set of spatial-frequency components of the input block. Any basis function that best decorrelates the given data may be used as a space frequency transform. An example basis function that can be used by the present teachings is DCT-II. As this basis is separable, it can be separately applied on each axis to improve performance of the encoding and decoding. (An illustrative example of transformed spatial-frequency coefficients are shown in FIG. 9 as denoted by reference numeral 901. In particular, this example presents a spatial-frequency transform of a 4×4×4 volumetric block into its spatial-coefficients.)

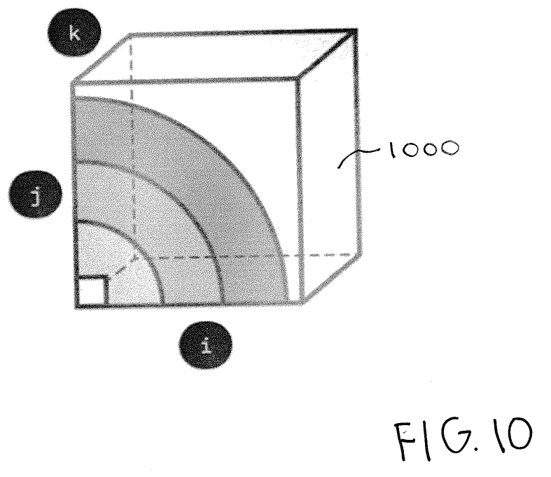

Quantization of transformed spatial-frequency components can be accomplished by normalizing the coefficients relative to their maximum value and rescaling their values based on their frequency to optionally control the amount of information of different spatial-frequency bands of the transformed block is provided for a perceptually best-looking reconstruction of the voxel's position and attributes. FIG. 10 provides an illustrative example of scaling values as a quantization scale of spatial-frequency coefficients inside of a block 1000.

The spatial-frequency component values can then be nonlinearly transformed to assign more weight to coefficients of relatively smaller magnitude. The nonlinear transformation may perform variable sampling depending on frequency and nonlinear sampling of the amplitude of the coefficient. The coefficients can subsequently be transformed into integers of a defined number of quantization steps.

By one approach, integer spatial-frequency coefficients lower than a given frequency-dependent threshold parametrized by a power law can be skipped in the sparse representation (for example, by being replaced by zero at the decoder stage). This approach can greatly reduce the size of the block with only a slight reduction in reconstruction quality. The parametrization of the quantization can be stored in the header of the corresponding frame.

Each volumetric block can be transformed into a collection of symbols representing their respective data. This approach can specify the following types of symbols that can be used to represent a block: block coordinate in a right-handed block index space coordinate system, scale of block coefficient components, number of sequential non-zero coefficients, indices representing the position of the coefficients, and the coefficients themselves for each given frequency. By one approach, these symbols can be computed in parallel for each block.

By one approach, these teachings can accommodate parallel entropy compression that may be comprised of two stages. A first stage can compute a statistical model that describes the specified value probability of each symbol of a given type. This can be achieved, for example, by counting the number of appearances of each value of each symbol type. A second stage can comprise encoding the block as a compressed binary representation that uses Huffman entropy encoding. The block binary representation can be applied in parallel for each block and afterwards all block binary strings can be concatenated into a single bitstream.

Volumetric displacement estimation solves the following equation.

$$\frac{\partial I}{\partial x} {V}_{x} + \frac{\partial I}{\partial y} {V}_{y} + \frac{\partial I}{\partial z} {V}_{z} + \frac{\partial I}{\partial t} = 0$$

where

$$\frac{\partial I}{\partial x} , \frac{\partial I}{\partial y} , \frac{\partial I}{\partial z}$$

are the spatial partial derivatives of the volume and

$$\frac{\partial I}{\partial t}$$

is the temporal derivative of the volume. The equation is approximated using finite differences.

$$\frac{I 1 [ i + 1 , j , k ] - I 1 [ i - 1 , j , k ]}{2 Δ x} {V}_{x} + \frac{I 1 [ i , j + 1 , k ] - I 1 [ i , j - 1 , k ]}{2 Δ y} {V}_{y} \frac{I 1 [ i , j , k + 1 ] - I 1 [ i , j , k - 1 ]}{2 Δ z} {V}_{z} = I 1 [ i , j , k ] - I 2 [ i , j , k ]$$

An overdetermined system of equations for Vₓ, V_{y}, V_{z} is defined for each region centered at (x,y,z) of given window size with the contribution of every voxel inside of it weighted by a Gaussian kernel function of a given radius and is then solved using the least squares method.

To implement steps of the decoding process, the encoder may encode the following syntax as compressed bitstream syntax, where:
cbi_indicator—indicates a bitstream type for system applications to interpret a type of coded bitstream being sparse volumetric coded bitstream. The value of the coded element is set to be equal to 0x71B9A5DBB71B9AA1;
cbi_version[i] indicates the i-th element of the version indication;
cbi_ufid is a unique file identifier which is randomly generated at compression; and
cbi_size_in_bytes indicates the coded file size in bytes.

| | Descriptor |
|---|---|
| coded_bitstream_info ( ) { | |
| cbi_indicator | u(64) |
| for (int i = 0; i < 4; i++) | |
| cbi_version[i] | u(16) |
| cbi_ufid | u(128) |
| cbi_size_in_bytes | u(64) |
| coded_bitstream_sequence_header ( ) | |
| coded_bitstream_sequence_payload ( ) | |
| } | |

In the following coded bitstream sequence header example:
cbsh_frame_count indicates the number of frames present in the coded bitstream;
cbsh_attribute_count indicates the maximum number of attributes present in the coded bitstream;
cbsh_original_size indicates the size of the original uncompressed volumetric sequence coded in the file;
cbsh_axis_aligned_bounding_box_size[i] indicates the size of the i-th component of the axis aligned bounding box of all the frames in the effect;
cbsh_max_word_count indicates maximum possible word count required to store the bitstream coded blocks of a frame;
cbsh_max_spatial_blocks_count indicates maximum number of spatial blocks in the effect;
cbsh_max_attribute_blocks_count indicates maximum number of attribute blocks in the effect;
cbsh_block_size indicates the size of the block in voxels;
cbsh_flags_mask contains flags representing the types of encoded data;
cbsh_metadata_parameter_count indicates a number of metadata parameters in the coded bitstream;
cbsh_sequence_start_index indicates the start index of the sequence of frames; and
cbsh_sequence_index_increment indicates the increment of every frame in the file.

| | Descriptor |
|---|---|
| coded_bitstream_sequence_header ( ) { | |
| cbsh_original_size | u(64) |
| cbsh_frame_count | u(32) |
| cbsh_attribute_count | u(32) |
| cbsh_framerate_numerator | u(32) |
| cbsh_framerate_denominator | u(32) |
| cbsh_flags_mask | u(32) |
| cbsh_metadata_parameter_count | u(32) |
| cbsh_sequence_start_index | i(32) |
| cbsh_sequence_index_increment | u(8) |
| cbsh_block_size | u(8) |
| cbsh_max_word_count | u(32) |
| cbsh_max_spatial_blocks_count | u(32) |
| if(cbsh_attribute_count ) | |
| cbsh_max_attribute_blocks_count | u(32) |
| for (j = 0; j < 3; j++) | |
| cbsh_axis_aligned_bounding_box_size[i] | u(32) |
| cbsh_license_info ( ) | |
| } | |

In the following example:
cpli_flags holds the property flags of the license; and
cpli_encrypted_data stores the information about the license encrypted using RSA-2048 with OAEP and SHA-256.

| | Descriptor |
|---|---|
| cbsh_license_info ( ) { | |
| cpli_flags | u(32) |
| cpli_encrypted_data | u(2048) |
| } | |

Continuing with these syntax examples:

Descriptor

```
coded_bitstream_sequence_payload ( ) {
  cbsp_metadata( )
  for (j = 0; j < cbsh_frame_count; j++)
    cbsp_frame( )[ j ]
}
```

In the following example:
cbsm_attribute_name[j] indicates an attribute name. Each channel is a string. Strings are stored as length of the string as uint16_t, followed by a respective number of chars;
cbsm_metadata[j] indicates a metadata. Each metadata entry is 2 strings. Strings are stored as length of the string as uint16_t, followed by a respective number of chars; and
cbsm_frame_offsest [j] indicates the beginning byte offset of the i-th frame in the coded bitstream.

| | Descriptor |
|---|---|
| cbsp_metadata( ) { | |
| for (j = 0; j < cbsh_attribute_count; j++) | |
| cbsm_attribute_name[ j ] | |
| for (j = 0; j < cbsh_metadata_parameter_count; j++) | |
| cbsm_metadata[ j ] | |
| for (j = 0; j < cbsh_frame_count; j++) | |
| cbsm_frame_offsest[ j ] | u(64) |
| } | |

In addition, the encoder may encode the following syntax as frame syntax.

Descriptor

```
coded_bitstream_frame( ) {
  cbf_header ( )
  cbf_payload ( )
}
```

In the following example:
cbfh_frame_size indicates the frame size in units of bytes;
cbfh_original_size indicates the original size of the uncompressed frame;
cbfh_frame_flags indicates the frame property flags;
cbfh_spatial_block_cnt indicates a number of blocks in a frame;
cbfh_blk_data_word_count indicates a number of words in the coded part of the bitstream holding the block data of the frame;
cbfh_blk_data_bits_per_block_element_cnt indicates the bit depth of each element in the array holding the encoded sparse block bit sizes;
cbfh_huffman_tree_data_element_cnt indicates the number of elements in the encoded array holding the Huffman trees;
cbfh_huffman_tree_bits_per_element indicates the bit depth of each encoded element of the Huffman tree;
cbfh_metadata_paremeter_cnt indicates the number of metadata parameters;
cbfh_attribute_count indicates the attribute count in this frame;
cbfh_attr_bit_cnt_bits_per_element indicates the number of elements in the array holding the bit offsets of each encoded attribute block; and
cbfh_attribute_blk_cnt indicates a number of attribute blocks.

| | Descriptor |
|---|---|
| cbf_header ( ) { | |
| // FRAME PROPERTIES | |
| cbfh_frame_size | u(64) |
| cbfh_original_size | u(64) |
| cbfh_frame_flags | u(32) |
| cbfh_spatial_block_cnt | u(32) |
| cbfh_blk_data_word_count | u(32) |
| cbfh_blk_data_bits_per_block_element_cnt | u(8) |
| cbfh_huffman_tree_data_element_cnt | u(16) |
| cbfh_huffman_tree_bits_per_element | u(8) |
| cbfh_metadata_paremeter_cnt | u(16) |
| if (cbsh_attribute_count) { | |
| cbfh_attribute_count | u(8) |
| cbfh_attr_bit_cnt_bits_per_element | u(8) |
| cbfh_attribute_blk_cnt | u(32) |
| for (int i = 0; i < cbfh_attribute_count; i++) | |
| cbfh_attribute_properties [ i ] ( ) | |
| } | |
| } | |

In the following example:
cbap_transform_matrix [i][j] is an i-th row and j-th column element of a 4×4 transformation matrix;
cbap_flags indicates the flags representing the properties of this attribute;
cbap_zero_offset indicates the zeroOffset parameter used herein;
cbap_scaling_factor indicates the scalingFactor parameter of this attribute used herein
cbap_scaling_offset indicates the scalingOffset parameter of this attribute used herein;
cbap_scaling_exponent indicates scalingExponent parameter of this attribute used herein
cbap_quantization_exponent for this attribute indicates quantization exponent value quantizationExpoenent, and gamma as used herein;
cbap_preprocess_exponent indicates alpha parameter of this attribute as used herein;
cbap_qunatization_parameter indicates the quantization parameter of this attribute as used herein;
cbap_attribute_scales indicates the scale factor of this attribute;
cbap_axis_aligned_bounding_box_size is an i-th element of the axis aligned bounding box of this attribute in this frame; and
cbap_attribute_index indicates the mapping of the i-th attribute in this frame to the file attribute list.

| | Descriptor |
|---|---|
| cbfh_attribute_properties ( ) { | |
| for (int i = 0; i < 4; i++) | |
| for (int j = 0; j < 4; j++) | |
| cbap_transform_matrix[ i ][ j ] | fl(32) |
| cbap_flags | u(32) |
| cbap_zero_offset | fl(32) |
| cbap_scaling_factor | f1(32) |
| cbap_scaling_offset | f1(32) |
| cbap_scaling_exponent | fl(32) |
| cbap_quantization_exponent | fl(32) |
| cbap_preprocess_exponent | fl(32) |
| cbap_qunatization_parameter | fl(32) |
| cbap_attribute_scale | fl(32) |
| for (int i = 0; i < 3; i++) | |
| cbap_axis_aligned_bounding_box_size[ i ] | u(16) |
| cbap_attribute_index | u(8) |
| } | |

In the following example:
cbfp_metadata indicates a frame metadata. Each metadata is a string. Strings are stored as length of the string as uint16_t, followed by a respective number of characters;
cbfp_block_bit_count[j] indicates the bit sizes of the coded spatial blocks;
cbfp_attr_bit_offset[j] indicates the bit offset in the coded bitstream of an attribute inside a block;
cbfp_coef_reorder[j] is an array with remap indices to get from list of coefficients to block; and
blockElementCount is the number of elements in a block and is equal to cbfh_block_size\hat{ }3.

All arrays with variable element size are assumed to have a zero padding at the end to align their byte size with an integer.

| | Descriptor |
|---|---|
| cbf_payload ( ) { | |
| for (j = 0; j < 2 * metadataParameterCount; j++) | |
| cbfp_metadata[ j ] | |
| for (j = 0; j < | |
| cbfh_huffman_tree_bitstream_element_cnt; j++) | |
| cbfp_huffman_tree[ j ]( ) | |
| for (j = 0; j < cbfh_spatial_block_cnt; j++) | |
| cbfp_block_bit_count[ j ] | ue(v) |
| for (j = 0; j < cbfh_attribute_block_cnt; j++) | |
| cbfp_attr_bit_offset[ j ] | ue(v) |
| for (j = 0; j < blockElementCount; j++) | |
| cbfp_coef_reorder[ j ] | ue(v) |
| for (i = 0; i < cbfh_spatial_block_cnt; i++) | |
| cbfp_block_node[ i ]( ) | |
| } | |

In the following example:
cbht_value the value of the Huffman tree node in the Huffman array; and
cbht_zero_count the number of zeros in the Huffman array.
   This codes an array of 14 Huffman tree arrays of size 1024. Each node of the Huffman tree is coded in cbht_value as (is_leaf?leaf_value:left_child_index)<<1|is_leaf, the right child node index being left_child_index+1 and with the root node being at index 0 of the tree array.

| | Descriptor |
|---|---|
| cbfp_huffman_tree ( ) { | |
| cbht_value | ue(v) |
| if(!cbht_value) { | |
| cbht_zero_count | ue(v) |
| } | |
| } | |

In addition to the foregoing, the encoder may encode the following syntax as block syntax.

Descriptor

```
cbfp_block_node ( ) {
  cbn_header( )
  for (j = 0; j < attributeCount; j++) {
    cbn_attribute_node( )
  }
}
```

In the following example:
cbnh_sp_blk_pos[i] indicates the i-th component of the position of the spatial block in units of blocks;
cbnh_attr_cnt indicates a number of attributes present in this spatial block;
cbnh_attr_blk_mask indicates which attributes are present in the spatial block. The number of set bits is equal to cbnh_attr_cnt. Each set bit at bit offset i indicates that an attribute of index i is present in this spatial block; and
cbnh_attr_blk_offset indicates the beginning offset index of this spatial block of the list of attribute blocks.
   To compute the offset of a given attribute in the attribute block list the number of set bits must be counted from least significant to, not including, the given attribute bit.

| | Descriptor |
|---|---|
| cbn_header ( ) { | |
| for (int i = 0; i < 3; i++) | |
| cbnh_sp_blk_pos[i] | u(8) |
| cbnh_attr_cnt | u(8) |
| for (int i = 0; i < (cbfh_attribute_count+7)/8; i++) | |
| cbnh_attr_blk_mask[i] | u(8) |
| cbnh_attr_blk_offset | u(24) |
| } | |

Descriptor

```
cbn_attribute_node ( ) {
  cban_header( )
  cban_payload( )
}
```

In the following example:
cbah_scale indicates the normalization constant of the block spatial-frequency coefficients (according to 3.1). The value is a logarithm base 2 of the normalization constant which is represented as a 16 bit fixed point value in range from −13.288 to 19; and
cbah_dense_coef_count indicates the number of sequential coded spatial-frequency coefficients.

| | Descriptor |
|---|---|
| cban_header ( ) { | |
| cbah_scale | u(16) |
| cbah_dense_coef_count | u(16) |
| } | |

In the following example:
cban_dense_spatial_frequency_coef[i] represents the i-th dense spatial-frequency coefficient;
cban_sparse_coef_zero_run indicates a number of coefficients equal to zero;
cban_sparse_spatial_frequency_coef represents a coefficient value, followed by the given number of zero coefficients; and
isSparseBlock is True when the number of currently read bits of the sparse block is less than the total number of bits in this sparse block.

| | Descriptor |
|---|---|
| cban_payload ( ) { | |
| //DENSE COEFFICIENT DATA | |
| for (i = 0; i < cban_dense_coef_count; i++) | |
| cban_dense_spatial_frequency_coef[ i ] | u(8) |
| //SPARSE COEFFICIENT DATA | |
| while(isSparseBlock) { | |
| cban_sparse_coef_zero_run | u(8) |
| cban_sparse_spatial_frequency_coef | u(8) |
| } | |
| } | |

The block syntax can be coded in the following way) every syntax element being split into bytes) each byte of which uses their respective Huffman tree for coding.

| Syntax element | Element byte | Tree Index |
|---|---|---|
| cbnh_sp_blk_pos[0] | 0 | 0 |
| cbnh_sp_blk_pos[1] | 0 | 1 |
| cbnh_sp_blk_pos[2] | 0 | 2 |
| cbnh attr_blk_offset | 0 | 3 |
| cbnh_attr_blk_offset | 1 | 4 |
| cbnh_attr_blk_offset | 2 | 5 |
| cbnh_attr_cnt | 0 | 6 |
| cbnh_attr_blk_mask[i] | 0 | 7 |
| cbah_scale | 0 | 8 |
| cbah_scale | 1 | 9 |
| cbah_dense_coef_count | 0 | 10 |
| cbah_dense_coef_count | 1 | 11 |
| cban_sparse_coef_zero_run | 0 | 12 |
| cban_dense_spatial_frequency_coef | 0 | 13 |
| cban_sparse_spatial_frequency_coef | 0 | 13 |

The coordinates are coded in the following way: index 0 is x, index 1 is y, index 2 is z, and index 3 is w.

In this example, the flags used in the coder are specified as follows.

| | |
|---|---|
| Name | Value |

cbsh_flags_mask

| | |
|---|---|
| Has Motion Fields | 0x1 |
| Unused | 0xFFFFFFFE |

cpli_flags

| | |
|---|---|
| Unused | 0xFFFFFFFF |

cbfh_frame_flags

| | |
|---|---|
| Is Motion Field | 0x1 |
| Unused | 0xFFFFFFFE |

cbap_flags

| | |
|---|---|
| Is Signed | 0x1 |
| Unused | 0xFFFFFFFE |

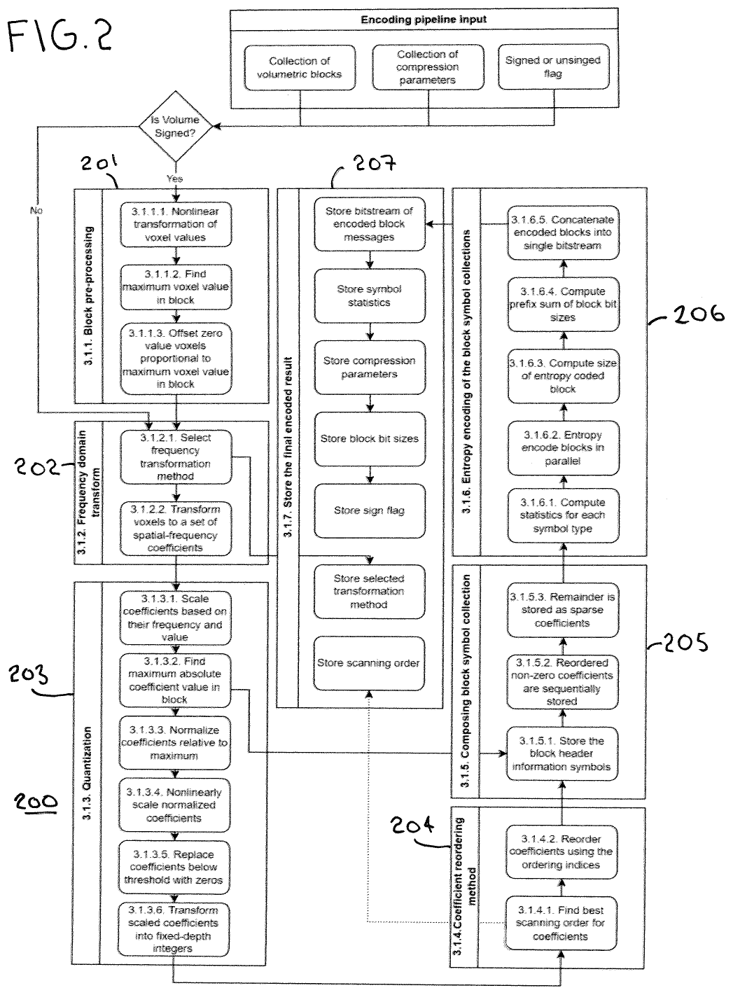

With the foregoing syntax conditions in mind, and referring now to FIG. 2, the frame encoding pipeline 200 for a corresponding codec is shown. The encoding method receives a collection of volumetric blocks with their given integer coordinates in the effect coordinate system, as well as a collection of compression parameters specifying the spatial-frequency transform parameters, and further including quantization parameters that directly affect the amount of information dedicated to representing the effect, which controls the final compression rate, and finally a Boolean flag specifying if the volume is signed or unsigned.

When the volume is unsigned, this pipeline 200 can provide for block pre-processing as denoted by reference numeral 201. First the values of the block voxels are optionally transformed, whereas the transformation can be nonlinear, to improve the representation of different scale values depending on the type of data. pow(attr[i],alpha[i]), where i is an index of the attribute.

Next, this pre-processing finds the maximum value of the attribute in the block and in the entire volume.

To avoid noise in highly visible transparent regions outside of the effect, the values outside of the effect are transformed into a negative range using an offset, which depends on the maximum value of the attributes within the block. This is to assure that after the lossy reconstruction, all values that were zero before will most likely be negative and can be clamped to zero thus reconstructing their value more accurately. This offset is equal to zeroOffset multiplied by the maximum value of the block.

Reference numeral 202 denotes the transformation of block attributes into the frequency domain. The spatial-frequency transform basis set can be selected depending on the type of compressed data. The spatial-frequency coefficients associated with the attributes can be computed using the selected transform. (An illustrative example of a spatial-frequency transform is shown in FIG. 9.) The selected basis set can then be stored.

Reference numeral 203 denotes transformed spatial frequency coefficient quantization. Here, The coefficients are scaled depending on their spatial frequency using the quantization parameters−coefficient*pow(scalingOffset+scalingFactor*frequency, scalingExponent). An illustrative example of scaling appears in FIG. 10. After finding the maximum absolute value of the spatial-frequency coefficients in the block, the scaled coefficients are normalized to the corresponding maximum coefficient value in the block. The normalization parameter value can be stored in coded bitstreams per block. The normalized coefficients are then nonlinearly scaled based on their value−(1.0−pow(1.0−gamma, coef))/gamma. All scaled normalized coefficients below a certain frequency dependent threshold are then replaced with zeroes to remove redundant information without great accuracy loss−coef<pow(frequency, quantizationExpoenent). Lastly, the scaled coefficients are transformed into integers of a defined number of quantization steps—round(coef*pow(2, depth))—where depth may be equal to 8.

Reference numeral 204 denotes a follow-on coefficient reordering method. To store the coefficients in memory efficiently, these teachings can provide for finding the best scanning order. This can comprise, for example, finding a space-filling curve that minimizes the differences between neighboring coefficients and that is ordered by descending value. The coefficients can then be reordered using this space-filling curve and composed according to the average coefficient amplitude for this volume.

Reference numeral 205 denotes an approach for composing the collection of symbols for each block. The block information, including position, normalization parameter value, and so forth is stored at the beginning of the block symbol collection. Non-zero coefficients can be reordered according to the space filling curve and then sequentially written to the block symbol collection. Any remaining coefficients can then be written in the form of sparse pairs representing their difference encoded position index and the integerized coefficient value.

Reference numeral 206 denotes entropy encoding of the symbols. The statistics for each symbol type corresponding to a block can be computed for the entire effect. The symbols of each block may be entropy encoded in parallel. The size of the entropy coded block is then computed as is the prefix sum of the block sizes to get the block offset in the bitstream. The prefix sum is stored in the coded bitstream and the binary representations of the blocks can be concatenated into a single bitstream using the computed offsets. (If desired, these teachings will accommodate implementing entropy coding utilizing hardware apparatus on the coding device, using, for example, an entropy coding engine of the video codec.)

Reference numeral 207 then denotes storing the collection of the bitstream of encoded block messages, bit sizes of the blocks, the statistics of the symbols, the used space-filling curve, the used frequency transform, and the utilized compression parameters.

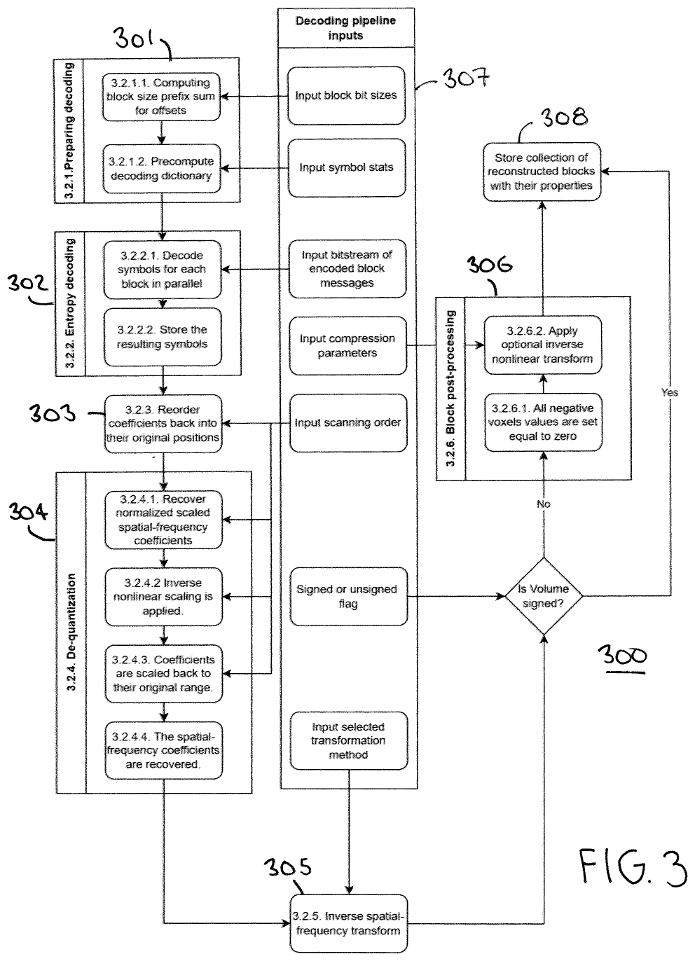

FIG. 3 presents the frame decoding pipeline 300 for a corresponding codec. Generally speaking, the decoding process receives as input the stored results of the above-described encoding method consisting of the encoded block messages, sizes of the blocks, index to the Huffman tree lookup table, the used reordering indices, the used frequency transform as a float matrix, used compression parameters, and a flag specifying if the volume is signed or unsigned.

Reference numeral 301 denotes preparation of the decoding pipeline. The binary offsets for each block's message in the bitstream are precomputed for optimal performance and a decoding dictionary is precomputed from the Huffman tables to increase the efficiency of the entropy decoding.

Reference numeral 302 denotes an entropy decoding step. In parallel for each block the encoded block messages are considered and, using the decoding dictionary, their values are decoded from their binary representation. The symbol values can be decoded in parallel using the symbol statistics from the coded bitstream. The resulting symbols are then stored.

Reference numeral 303 denotes coefficient reordering, where the coefficients are reordered back into their initial positions using the space-filling curve with the remainder of the coefficients being assigned to zero.

Reference numeral 304 denotes de-quantization. The normalized scaled spatial-frequency coefficient values are recovered by rescaling integers back into unit range. Inverse nonlinear scaling can be applied −1.0/log(1.0−coef*gamma)/log(1.0−gamma). The coefficients can then be scaled back to their original range by multiplying them by the normalization parameter. The spatial-frequency coefficients can be recovered by scaling them by the inverse of a frequency dependent scale−coefficient/pow(scalingOffset+scalingFactor*frequency, scalingExponent).

Reference numeral 305 denotes application of an inverse spatial-frequency transform.

Reference numeral 306 denotes block post-processing. This post-processing, in this example, is only applied when the volume is unsigned. Pursuant to this post-processing, all negative voxel attribute values are set to be equal to zero and the optional inverse nonlinear transform is applied to the decoded voxel attribute values −pow(attr[i],−alpha[i]), where i is an index of the attribute. (When the volume is signed, the collection of reconstructed blocks, along with their properties, is stored as denoted by reference numeral 308.)

Reference numeral 307 denotes decoding various pipeline inputs to feed the aforementioned steps, functions, and activities.

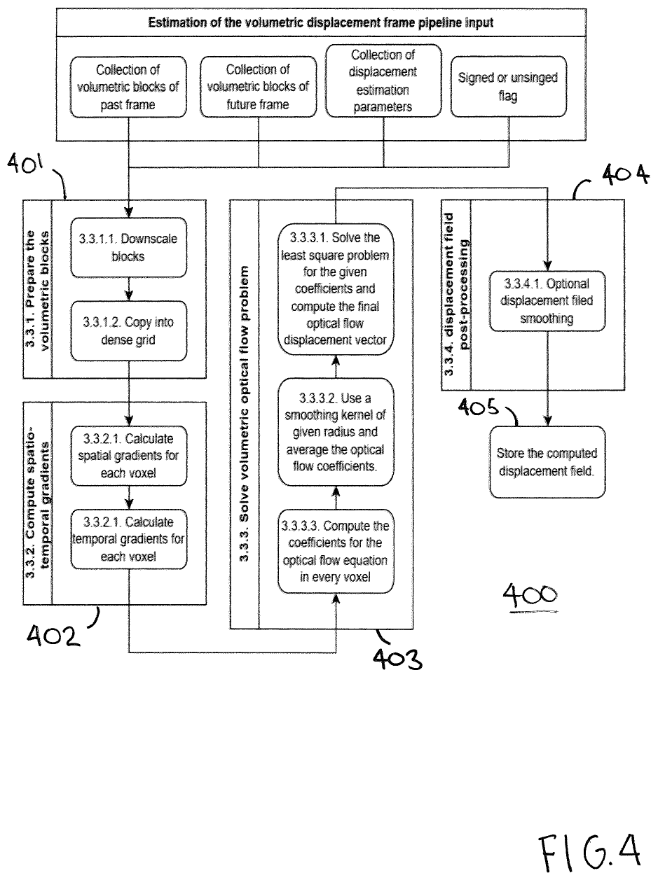

FIG. 4 illustrates an estimation of the volumetric displacement frame pipeline 400. Generally speaking, these teachings will accommodate estimating volumetric displacement by receiving 2 frames (in particular, a past and a future one) consisting of volumetric blocks with their integer positions in the effect coordinate system, and displacement estimation parameters, which include the resolution of the computed displacement field, which is specified as a downscale factor relative to the effect resolution, smoothing window radius in voxels, voxel range and target channels used for the displacement estimation.

Reference numeral 401 denotes preparing the volumetric blocks. This comprises computing the downsampled version of the blocks according to a corresponding spatial scale coefficient and coping the required attributes[idx] of downscaled sparse volumetric blocks into a dense grid of voxels.

Reference numeral 402 denotes computing spatio-temporal gradients by computing the gradients for each voxel for each spatial direction and the temporal direction between the 2 frames using first order central finite difference stencils for the spatial gradients and a forward first order stencil for the temporal derivative.

Reference numeral 403 denotes solving a corresponding volumetric displacement equation. This comprises computing the coefficients for the displacement equation in every voxel and using a smoothing kernel of the given radius and averaging the equation coefficients. This can be followed by solving an optimization problem, where the optimization problem can be a least square problem for the given coefficients and yield the final optical flow displacement vector.

Reference numeral 404 denotes displacement field post-processing, which is followed by storage of the computed displacement field 405.

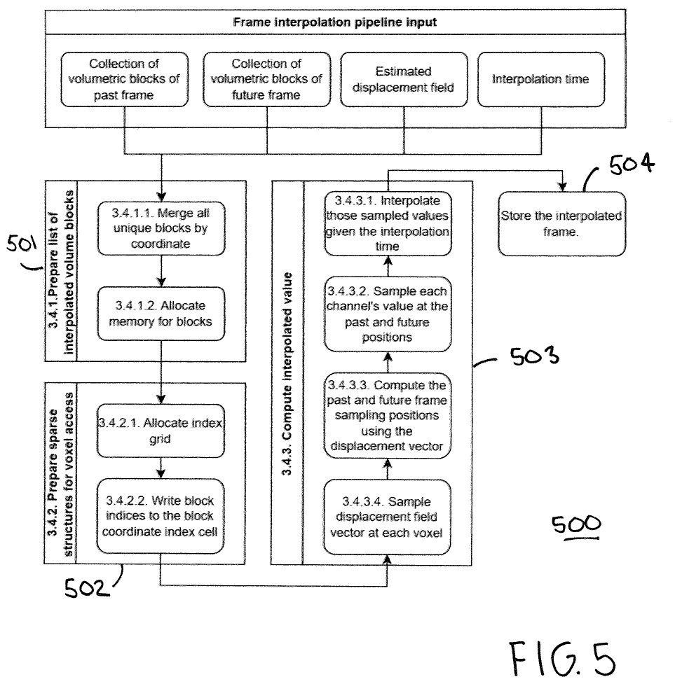

FIG. 5 presents an illustrative example of a frame interpolation pipeline 500 that accords with these teachings. Generally speaking, this frame interpolation pipeline 500 provides for receiving both future and past frames together with their estimated displacement field and their interpolation time.

Reference numeral 501 denotes the preparation of a list of interpolated volume blocks that comprises merging all unique block coordinates of each frame together into a single list and then allocating memory for blocks for each unique coordinate.

Reference numeral 502 denotes preparing sparse structures for voxel access and allocating an index grid of the size of the frame bounding box and initializing with no block indices. An index is written for each block at its coordinate in the index grid.

Reference numeral 503 denotes computing interpolated values. For each voxel of the created volume, the displacement field vector value at their position is sampled. Using the sampled displacement vector and the target interpolation time, these teachings then provide for computing the past and future frame sampling positions by interpolating between a past estimated position and a future estimated position. Each channel's value is then sampled at the past and future volumes at the computed positions using the sparse structure and those sampled values are then interpolated given the interpolation time.

The interpolated frame is then stored 504.

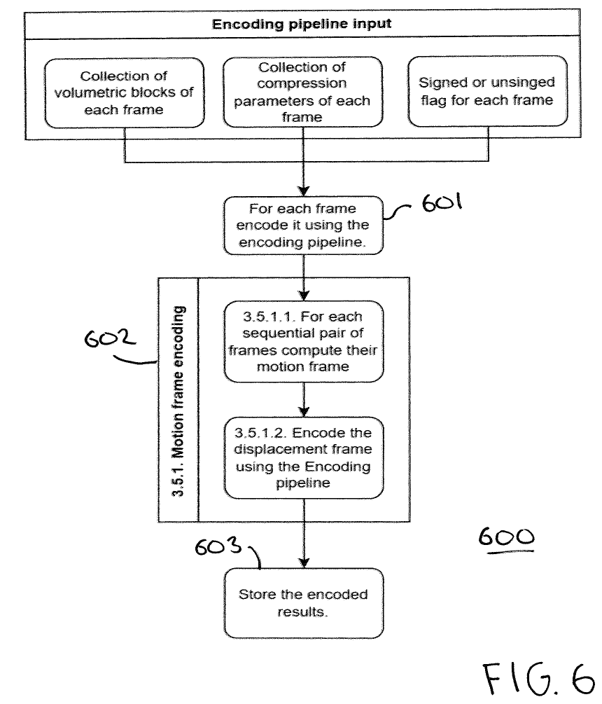

FIG. 6 presents a sequence of frames encoding pipeline 600 that generally comprises receiving a sequence of inputs that are required for the encoding pipeline. Reference numeral 601 denotes that each frame is encoded using the encoding pipeline 600. In particular, and as denoted by reference numeral 602, this can comprise computing the motion/displacement frame for each sequential pair of frames (using, for example, the estimation of the volumetric displacement frame pipeline 400 and then encoding the motion/displacement frame using the encoding pipeline. The reference numeral 603 denotes storing the encoded results in a coded bitstream.

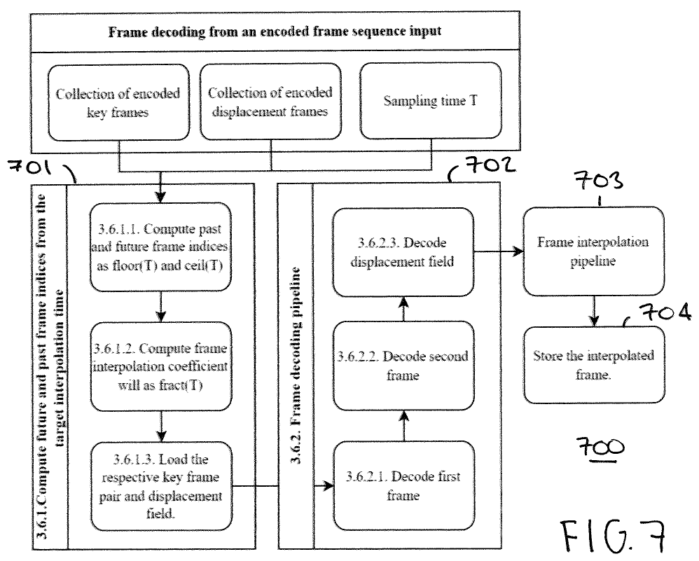

FIG. 7 presents a frame decoding process 700, and in particular frame decoding from an encoded frame sequence. In general, this process 700 receives the target interpolation time T and the encoded frame sequence.

Reference numeral 701 denotes preparing the required encoded data from the sequence. In this illustrative example, the past frame index is computed as floor(T) and the future frame index is ceil(T). The frame interpolation coefficient will be fract(T). The respective future and past frames are loaded as is the displacement field at the index of the past frame.

Reference numeral 702 denotes frame decoding and includes decoding the first frame, decoding the second frame, and decoding the displacement field.

At reference numeral 703 the aforementioned results are provided to the frame interpolation pipeline 500 where the final interpolated frame is computed and then output to be stored as the interpolated frame as denoted by reference numeral 704.

FIG. 8 presents an example 800 of sparse representation of volumetric data, consisting of 4 blocks, in accord with the teachings presented herein.

Those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

1. A method comprising:
by a control circuit:
dividing a volumetric dataset into a plurality of volumetric blocks;
applying a spatial-frequency transform to each of the volumetric blocks to obtain transform-domain coefficients;
quantizing the transform-domain coefficients according to one or more quantization parameters to provide quantized coefficients;
reordering the quantized coefficients based on a scanning order determined to reduce coefficient differences;
composing a collection of symbols for each volumetric block, the collection of symbols including at least a block header and a sparse representation of non-zero coefficients;
entropy encoding at least some of the symbols to generate a compressed bitstream; and
storing the compressed bitstream in memory.

2. The method of claim 1, further comprising, for unsigned volumetric datasets, introducing a negative offset to voxel values having a density attribute below a user-specified threshold, the negative offset being a product of a zeroOffset parameter and a maximum voxel value within each volumetric block.

3. The method of claim 1, wherein quantizing the transform-domain coefficients includes omitting coefficients below a threshold defined by a power-law function of an absolute frequency of a corresponding voxel and a user-specified exponent.

4. The method of claim 1, wherein quantizing the transform-domain coefficients comprises:
normalizing the transform-domain coefficients by dividing by a block-specific maximum coefficient magnitude;
applying a nonlinear quantization function to emphasize smaller coefficients and to provide normalized transform-domain coefficients; and
converting the normalized transform-domain coefficients into integer values.

5. The method of claim 1, wherein reordering the quantized coefficients comprises sorting according to coefficient magnitude or by utilizing a space-filling curve to place coefficients with smaller differences adjacent to each other.

6. The method of claim 1, wherein the entropy encoding comprises:
encoding non-zero coefficients using a zero-run scheme for intervening zero-valued coefficients; and
applying Huffman coding to resulting symbols, wherein multiple Huffman trees are used, each corresponding to a different symbol type.

7. The method of claim 1, wherein reordering the quantized coefficients comprises determining a scanning order by sorting the quantized coefficients according to an average value of each coefficient across a volumetric frame.

8. The method of claim 1, further comprising:
normalizing the transform-domain coefficients for each volumetric block to a range of −1 to 1 based on a block-specific maximum absolute coefficient value; and
storing a corresponding normalization parameter for each volumetric block in the compressed bitstream such that an original coefficient range can be reconstructed at decoding.

9. The method of claim 1, wherein the volumetric dataset is unsigned, and further comprising:
transforming voxel attribute values by applying a nonlinear function pow(attr[i], α[i]) prior to applying the spatial-frequency transform.

10. The method of claim 1, further comprising:
storing a bit offset for each volumetric block's portion of the compressed bitstream, thereby enabling parallel entropy encoding and decoding of multiple blocks on a graphics processing unit or other parallel-processing hardware.

11. The method of claim 1, further comprising:
encoding spatial-frequency coefficients by:
encoding a predefined number N of largest coefficients of spatial-frequency components as a dense array for each volumetric block; and
encoding remaining one of the spatial-frequency coefficients using a sparse representation that incorporates zero-run coding.

12. The method of claim 1, wherein storing the compressed bitstream in memory comprises storing an encoded bitstream of a plurality of volumetric blocks, each of the volumetric blocks being represented by:
block properties, including at least a position within a volumetric coordinate space and a count of attributes;
and for each attribute of the volumetric blocks:
a normalization scale indicating a coefficient range for each of the volumetric blocks;
a number of dense coefficients;
a sequence of dense coefficients; and
a sequence of coefficients encoded in a sparse format using zero-run encoding.

13. A method for decoding sparse volumetric frames from a compressed bitstream, comprising:
by a control circuit:
entropy decoding symbols for each of a plurality of volumetric blocks to provide decoded coefficients;
inverse reordering of the decoded coefficients based on a predetermined scanning order to provide inverse reordered decoded coefficients;
dequantizing the inverse reordered decoded coefficients to restore approximate transform-domain values;
applying an inverse spatial-frequency transform to generate reconstructed volumetric blocks; and
performing a post-processing step to finalize voxel values of the reconstructed volumetric blocks.

14. The method for decoding sparse volumetric frames from a compressed bitstream of claim 13, wherein dequantizing the inverse reordered decoded coefficients includes retrieving a normalization parameter for each volumetric block from the compressed bitstream and multiplying each inverse reordered decoded coefficient by a corresponding normalization parameter to restore the inverse reordered decoded coefficients to at least approximately their original amplitude range.

15. The method for decoding sparse volumetric frames from a compressed bitstream of claim 13, further comprising:
applying an inverse of a previously utilized nonlinear function to each voxel's attribute value after dequantizing, wherein the inverse spatial-frequency transform is at least pow(attr[i], −α[i]) to recover approximate original attribute values.

16. The method for decoding sparse volumetric frames from a compressed bitstream of claim 13, further comprising:
using a per-block offset for parallel entropy decoding of multiple volumetric blocks on a graphics processing unit or other parallel-processing hardware.

17. The method for decoding sparse volumetric frames from a compressed bitstream of claim 13, further comprising:
decoding spatial-frequency coefficients by:
decoding a predefined number N of coefficients as a dense array for each volumetric block; and
decoding remaining coefficients using a sparse representation that incorporates zero-run coding.

18. A non-transitory computer-readable medium comprising instructions stored thereon for encoding sparse volumetric information, which instructions, when executed on a processor, perform the steps of:
dividing a volumetric dataset into a plurality of volumetric blocks;
applying a spatial-frequency transform to each of the volumetric blocks to obtain transform-domain coefficients;
quantizing the transform-domain coefficients according to one or more quantization parameters to provide quantized coefficients;
reordering the quantized coefficients based on a scanning order determined to reduce coefficient differences;
composing a collection of symbols for each volumetric block, the collection of symbols including at least a block header and a sparse representation of non-zero coefficients;
entropy encoding at least some of the symbols to generate a compressed bitstream; and
storing the compressed bitstream in memory.

19. The non-transitory computer-readable medium of claim 18 wherein quantizing the transform-domain coefficients comprises:
normalizing the transform-domain coefficients by dividing by a block-specific maximum coefficient magnitude;
applying a nonlinear quantization function to emphasize smaller coefficients and to provide normalized transform-domain coefficients; and
converting the normalized transform-domain coefficients into integer values.

20. The non-transitory computer-readable medium of claim 18 wherein the instructions further provide for:
normalizing the transform-domain coefficients for each volumetric block to a range of −1 to 1 based on a block-specific maximum absolute coefficient value; and
storing a corresponding normalization parameter for each volumetric block in the compressed bitstream such that an original coefficient range can be reconstructed at decoding.
